(19) United States
(12) Patent Application Publication
(10) Pub. No.: US 2018/0114375 A1
(43) Pub. Date: Apr. 26, 2018

(54) METHOD, DEVICE AND SYSTEM FOR AUTOMATIC TIME RECORDAL

(71) Applicant: Nathan John Lucas, Flinders, Victoria (AU)

(72) Inventor: Nathan John Lucas, Flinders, Victoria (AU)

(21) Appl. No.: 15/559,119

(22) PCT Filed: Mar. 17, 2016
(86) PCT No.: PCT/AU2016/050191

§ 371 Date: Sep. 18, 2017

(30) Foreign Application Priority Data
Mar. 20, 2015 (AU) 2015901009

(51) Int. Cl. G07C 1/12; G06Q 10/10; G06F 17/30

(52) U.S. Cl. CPC G07C 1/12; G06F 17/30241; G06Q 10/1091

(57) ABSTRACT

A method for automatic time recordal, comprising: monitoring a portable device to determine whether or not a location of the portable device matches any one of a set of locations at which a person associated with the portable device is set to perform an activity; and upon determining that the location of the portable device matches one of the set of locations, generating duration data for enabling a determination of a duration of time spent by the portable device at the matched location.

### FIELD

The invention relates to a method, device and system for automatic time recordal.

### BACKGROUND

Currently, most service providers (including gardeners, pool cleaners and tradespersons such as technicians) manually monitor the duration of time spent at each job in order to keep track of the cost of the job. For example, a technician repairing or fixing an electrical fault at a residential premise may manually jot down using a pen on a piece of paper the time the technician entered the residential premise and the time the technician left the residential premise, in order to later invoice the cost of repairing or fixing the electrical fault after repairing or fixing the electrical fault. If an enquiry for another job is received by the technician while the technician is repairing or fixing the electrical fault, the technician may manually record the amount of time spent by the technician to attend to the enquiry, and deduct the recorded amount of time when preparing the invoice for repairing or fixing the electrical fault.

There is a need for an alternative or improved method for recording time.

### SUMMARY OF INVENTION

In a first aspect, the invention provides a method for automatic time recordal, comprising:

monitoring a portable device to determine whether or not a location of the portable device matches any one of a set of locations at which a person associated with the portable device is set to perform an activity; and

upon determining that the location of the portable device matches one of the set of locations, generating duration data for enabling a determination of a duration of time spent by the portable device at the matched location.

In an embodiment, generating the duration data comprises determining a start time at which the location of the portable device first matches the matched location, and wherein the duration data is indicative of the start time.

In an embodiment, generating the duration data comprises determining an end time at which the location of the portable device last matches the matched location, and wherein the duration data is indicative of the end time.

In an embodiment, determining whether or not the location of the portable device matches any one of the set of locations comprises comparing the location of the portable device to each one of the set of locations in order to determine whether or not the location of the portable device is within a predetermined distance of the location.

In an embodiment, determining that the location of the portable device matches the matched location comprises determining that the location of the portable device is within the predetermined distance of the matched location.

In an embodiment, the set of locations consists of one location.

In an embodiment, the method further comprises determining the set of locations.

In an embodiment, determining the set of locations comprises:

transmitting a location set identifier to a server for the server to locate the set of locations from a plurality of locations stored in a location database based on the location set identifier; and

receiving from the server the set of locations located from the plurality of locations stored in the location database based on the location set identifier.

In an embodiment monitoring the portable device comprises monitoring the location of the portable device.

In an embodiment, monitoring the portable device comprises monitoring a flag that can be set by the portable device.

In an embodiment, the method further comprises storing the duration data in a duration database.

In an embodiment, the method further comprises transmitting the duration data to a server in communication with a duration database for the server to:

determine the duration of time spent, by the portable device at, the matched location; and

generate and store in the duration database data indicative of the duration.

In an embodiment, the location set identifier is an identifier of the person associated with the portable device.

In a second aspect, the invention provides a portable device for automatic time recordal, comprising:

a location monitor arranged to monitor the portable device to determine whether or not a location of the portable device matches any one of a set, of locations at which a person associated with the portable device is set to perform an activity; and

a duration data generator arranged to, upon the location monitor determining that the location of the portable device matches one of the set of locations, generate duration data for enabling a determination of a duration of time spent by the portable device at the matched location.

In an embodiment, the duration data, generator comprises a start time determiner arranged to determine a start time at which the location of the portable device first matches the matched location, and wherein the duration data is indicative of the start time.

In an embodiment, the duration data generator comprises an end time determiner arranged to determine an end time at which the location of the portable device last matches the matched location, and wherein the duration data is indicative of the end time.

In an embodiment, the location monitor determines whether or not the location of the portable device matches any one of the set of locations, by comparing the location of the portable device to each one of the set of locations in order to determine whether or not the location of the portable device is within a predetermined distance of the location.

In an embodiment, the location monitor determines that the location of the portable device matches the matched location, by determining that the location of the portable device is within the predetermined distance of the matched location.

In an embodiment, the set of locations consists of one location.

In an embodiment, the device further comprises a location set determiner arranged to determine the set of locations.

In an embodiment, the location set determiner is arranged to:

control a transmitter to transmit a location set identifier to a server for the server to locate the set of locations from a plurality of locations stored in a location database based on the location set identifier; and

control a receiver to receive from the server the set of locations located from a plurality of locations stored in the location database based on the location set identifier.

In an embodiment, the location monitor monitors the portable device, by monitoring the location of the portable device.

In an embodiment, the location monitor monitors the portable device, by monitoring a flag that can be set by the portable device.

In an embodiment, the device further comprises memory for storing the duration data.

In an embodiment, the device further comprises a duration data transmitter arranged to transmit the duration data to a server in communication with a duration database for the server to:

determine the duration of time spent by the portable device at the matched location; and

generate and store in the duration database data indicative of the duration.

In an embodiment, the location set identifier corresponds to an identifier of the person associated with the portable device.

In a third aspect, the invention provides a server for automatic time recordal, comprising:

a duration data receiver arranged to receive duration data for enabling a determination of a duration of time spent by a portable device at the matched location, the duration data being determined upon a determination that a location of the portable device matches any one of a set of locations at which a person associated with the portable device is set to perform an activity;

a duration determiner arranged to determine the duration based on the duration data.

In an embodiment, duration data is indicative of a start time at which the location of the portable device first matches the matched location.

In an embodiment, the duration data is indicative of an end time at which the location of the portable device last matches the matched location.

In an embodiment, the duration data is indicative of both a start time at which the location of the portable device first matches the matched location and an end time at which the location of the portable device last matches the matched location.

In an embodiment, the portable device determines that the location of the portable device matches the matched location, by determining that the location of the portable device is within a predetermined distance of the matched location.

In an embodiment, the set of locations consists of one location.

In an embodiment, the server further comprises a location set determiner arranged to determine the set of locations.

In an embodiment, the location set determiner comprises:

an identifier receiver arranged to receive a location set identifier from the portable device; and

a location set locator arranged to locate the set of locations from a plurality of locations stored in a location database based on the location set identifier;

In an embodiment, the server further comprises a duration database modifier arranged to modify a duration database to store the duration data.

In an embodiment, the server further comprises the duration database.

In an embodiment, the location set identifier is an identifier of the person associated with the portable device.

In a fourth aspect, the invention provides a system for automatic time recordal, comprising:

a server and a plurality of portable devices in communication with the server,

the system arranged to, for each portable device:
monitor the portable device to determine that a location of the portable device matches any one of a set of locations at which a person associated with the portable device is set to perform an activity; and
upon determining that the location of the portable device matches one of the set of locations, generate duration data for enabling a determination of a duration of time spent by the portable device at the matched location.

In a fifth aspect, the invention provides a method for automatic time recordal, comprising:

monitoring a portable device to determine whether or not the portable device is at a location for a duration of time that exceeds a defined duration of time; and

upon determining that the portable device is at the location for the duration of time that exceeds the defined duration of time, generating in memory a location record for enabling a recordal of a duration of time spent by a person associated with the portable device at the location and associating the duration of time spent by the person with the location.

In an embodiment, the method further comprises displaying a request for confirmation that the person associated with the portable device is performing a job or work related activity at the location.

In an embodiment, the method further comprises receiving a confirmation that the person associated with the portable device is performing the job or work related activity at the location.

In an embodiment, the location record comprises location data for enabling a determination of the location.

In an embodiment, the method further comprises determining the location based on the location data, and wherein the displayed request comprises the location determined based on the location data.

In an embodiment, the record comprises duration data for enabling a determination of the duration of time spent by the portable device at the location.

In an embodiment, the method further comprises determining the duration of time spent by the person associated with the portable device at the location based on the duration data, and wherein the displayed request comprises the duration of time determined based on the duration data.

In an embodiment, the duration data comprises a start time at which the portable device is first at the location, and wherein the duration data is indicative of the start time.

In an embodiment, the duration data comprises an end time at which the portable device is last at the location, and wherein the duration data is indicative of the end time.

In an embodiment, determining that the portable device is at the location for a duration of time that exceeds the defined duration of time comprises determining, at each one of a plurality of times, a location of the portable device.

In an embodiment, determining that the portable device is at the location for a duration of time that exceeds the defined duration of time comprises comparing the location of the portable device determined at a reference time by a Global Positioning System (GPS) device to the location of the portable device determined, at a subsequent time by the GPS device, in order to determine whether or not the location of the portable device determined at the reference time is within a predetermined distance of the location of the portable device determined at the subsequent time.

In an embodiment, determining that the portable device is at the location for a duration of time that exceeds the defined duration of time comprises, upon determining that the location of the portable device determined at the reference time is within a predetermined distance of the location of the portable device determined at the subsequent time, comparing the reference time and the subsequent time, in order to determine whether or not the reference time and the subsequent time are separated by at least a defined duration of time.

In an embodiment, the method further comprises determining that a location of the portable device do not match any one of a set of locations at which the person associated with the portable device is set to perform an activity.

In an embodiment, determining that the location of the portable device do not match any one of the set of locations comprises determining that the location of the portable device is not within a predetermined distance of any one of the set of locations.

In an embodiment, the method further comprises determining the set of locations.

In an embodiment, determining the set of locations comprises:

transmitting a location set identifier to a server for the server to locate the set of locations from a plurality of locations stored in a location database based on the location set identifier; and

receiving from the server the set of locations located from the plurality of locations stored in the location database based on the location set identifier.

In an embodiment, monitoring the portable device comprises monitoring the location of the portable device.

In an embodiment, monitoring the portable device comprises monitoring a flag that can be set by the portable device.

In an embodiment, the method further comprises storing the record in a duration database.

In an embodiment, the method further comprises transmitting the record o a server in communication with a duration database for the server to:

determine the duration of time spent by the portable device at the location; and

generate and store in the duration database data indicative of the duration.

In an embodiment, the location set identifier is an identifier of the person associated with the portable device.

In a sixth aspect, the invention provides a portable device for automatic time recordal, comprising:

a location monitor arranged to monitor the portable device to determine whether or not the portable device is at a location for a duration of time that exceeds a defined duration of time; and

a location record generator arranged to, upon the location monitor determining that the portable device is at the location for the duration of time that exceeds the defined duration of time, generate in memory a location record for enabling a recordal of a duration of time spent by a person associated with the portable device at the location and associating the duration of time spent by the person with the location.

In an embodiment, the portable device further comprises a confirmation request generator for controlling a display to display a request for confirmation that the person associated with the portable device is performing a job or work related activity at the location.

In an embodiment, the portable device further comprises an input device for receiving a confirmation that the person associated with the portable device is performing the job or work related activity at the location.

In an embodiment, the location record comprises location data for enabling a determination of the location.

In an embodiment, the confirmation request generator is arranged to determine the location based on the location data, and wherein the displayed request comprises the location determined based on the location data.

In an embodiment, the record comprises duration data for enabling a determination of the duration of time spent by the portable device at the location.

In an embodiment, the portable device further comprises a duration data generator is arranged to determine the duration of time spent by the person associated with the portable device at the location based on the duration data, and wherein the displayed request comprises the duration of time determined based on the duration data.

In an embodiment, the duration data generator comprises a start time determiner arranged to determine a start time at which the portable device is first at the location, and wherein the duration data is indicative of the start time.

In an embodiment, the duration data generator comprises an end time determiner arranged to determine an end time at which the portable device is last at the location, and wherein the duration data is indicative of the end time.

In an embodiment, the portable device further comprises a Global Positioning System (GPS) device for determining a location of the portable device.

In an embodiment, the location monitor is arranged to compare the location of the portable device determined at a reference time by the GPS device to the location of the portable device determined at a subsequent time by the GPS device, in order to determine whether or not the location of the portable device determined at the reference time is within a predetermined distance of the location of the portable device determined at the subsequent time.

In an embodiment, the location monitor is arranged to compare the reference time and the subsequent time, in order to determine whether or not the reference time and the subsequent time are separated by at least a defined duration of time.

In an embodiment, the location monitor determines that the portable device is at a location for a duration of time that exceeds the defined duration of time, upon determining that the location of the portable device determined at the reference time is within the predetermined distance of the location of the portable device determined at the subsequent time and that the reference time and the subsequent time are separated by at least the minimum defined duration of time.

In an embodiment, the location monitor is arranged to determine that a location of the portable device do not match any one of a set of locations at which the person associated with the portable device is set to perform an activity.

In an embodiment, the location monitor determines that the location of the portable device do not match any one of the set of locations, by determining that the location of the portable device is not within a predetermined distance of any one of the set of locations.

In an embodiment, the portable device further comprises a location set determiner arranged to determine the set of locations.

In an embodiment, the location set determiner is arranged to:

control a transmitter to transmit a location set identifier to a server for the server to locate the set of locations from a plurality of locations stored in a location database based on the location set identifier; and

control a receiver to receive from the server the set of locations located from a plurality of locations stored in the location database based on the location set identifier.

In an embodiment, the location monitor monitors the portable device, by monitoring the location of the portable device.

In an embodiment, the location monitor monitors the portable device, by monitoring a flag that can be set by the portable device.

In an embodiment the portable device further comprises memory for storing the duration data.

In an embodiment, the portable device further comprises a duration data transmitter arranged to transmit the duration data to a server in communication with a duration database for the server to:

determine the duration of time spent by the portable device at the location; and

generate and store in the duration database data indicative of the duration.

In an embodiment, the location set identifier corresponds to an identifier of the person associated with the portable device.

In a seventh aspect, the invention provides a system for automatic time recordal, comprising:

a server and a plurality of portable devices in communication with the server,

the system arranged to, for each portable device:
monitor the portable device to determine whether or not the portable device is at a location for a duration of time that exceeds a defined duration of time; and
upon determining that the portable device is at the location for the duration of time that exceeds the defined duration of time, generating in memory a location record for enabling a recordal of a duration of time spent by a person associated with the portable device at the location and associating the duration of time spent by the person with the location.

### BRIEF DESCRIPTION OF THE DRAWINGS

In order that the invention may be more clearly ascertained, embodiments will now be described, by way of example, with reference to the accompanying drawings, in which:

FIG. 1 is a schematic diagram of the physical architecture of an embodiment of the system for automatic time recordal;

FIG. 2 is a schematic diagram of the functional components of the system of FIG. 1;

FIGS. 3 and 4 are flow charts illustrating an embodiment of the method for automatic time recordal, carried out using the system of FIGS. 1 and 2;

FIG. 5 is a flow chart of an alternative embodiment of the method for automatic time recordal;

FIG. 6 is a flow chart of an alternative embodiment of a method for automatic time recordal; and

FIGS. 7 to 10 are screenshots of the display of a smartphone of an alternative embodiment of the system for automatic time recordal.

### DETAILED DESCRIPTION

Referring to the drawings, there is shown an embodiment of a method for automatic time recordal performed by a system 10. According to the method, a portable device 13 of the system 10 is first monitored to determine whether or not a location of the portable device 13 matches any one of a set of locations at which a person (for example, an electrician using the portable device 13) associated with the portable device 13 is set to perform an activity (for example, repair or fix an electrical fault). Upon determining that the location of the portable device 13 matches one of the set of locations, duration data indicative of a duration of time spent by the portable device 13 at the matched location is then generated.

This automatic time recordal method is advantageous in that it enables automatic recordal of time of a user of the system 10 without requiring the user to manually keep track of his or her location, or monitor the duration of time spent at jobs. The system 10 is also advantageous in that a user of the system 10 need not manually match his or her location to relevant jobs, or manually input time recordal information. Furthermore, the system 10 advantageously centralizes the administration and allocation of jobs for multiple users of the system 10 in real-time. For example, a new job may be allocated by an administrator of the system 10 to a user of the system 10 while the user is attending to an existing job, without interrupting the user.

Person skilled in the art will appreciate that the person associated with the portable device 13 may not be an electrician or a tradesperson, and may be any person in an alternative embodiment. Persons skilled in the art will also appreciate the activity may not be to repair or fix an electrical fault in an alternative embodiment. For example, in an alternative embodiment, the activity may be to attend a meeting.

In addition to the method for automatic time recorder mentioned above, in the drawings, there is also shown an embodiment of an alternative method for automatic time recordal. In this alternative embodiment, the portable device 13 of the system 10 is monitored to determine whether or not the portable device 13 is at a location for a duration of time that exceeds a defined duration of time. If so, upon a determination that the portable device 13 is at the location for a duration of time that exceeds the defined duration of time, a location record for (i) enabling a recordal of a duration of time spent by a person (such as an, electrician using the portable device 13A as indicated above) associated with the portable device 13 at the location and (ii) associating the duration of time spent by the person with the location is generated in a memory.

This alternative automatic time recordal method is advantageous in that it enables automatic recordal of the time a user of the system 10 spends on an job or activity (for example, a job to urgently repair or fix an electrical fault that was not previously scheduled or known) of which the location is previously not known without requiring the user to manually keep track of his or her location, or monitor the duration of time spent at the job.

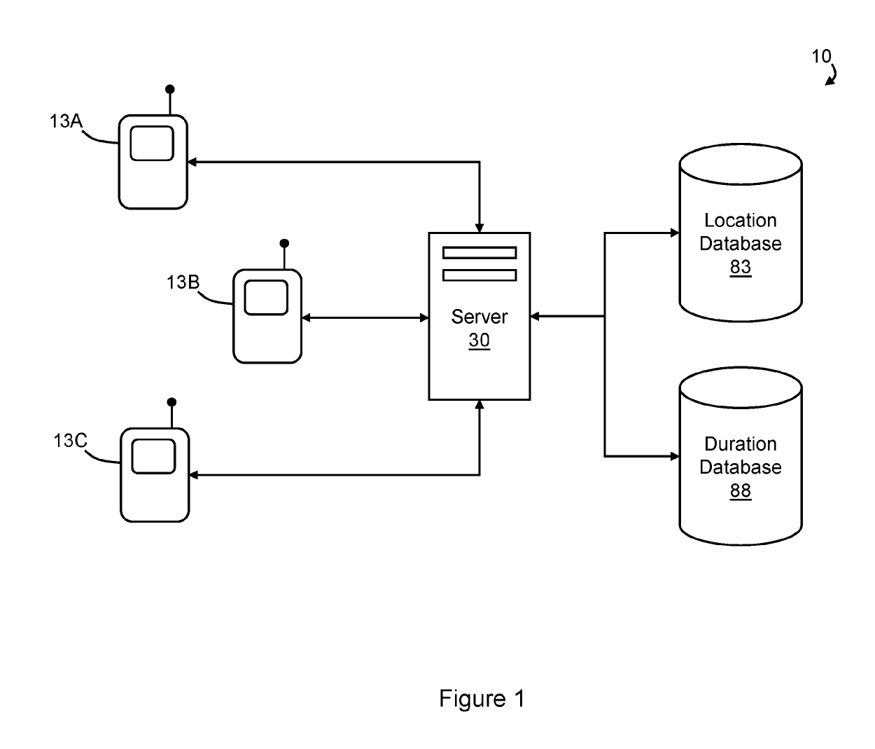

FIG. 1 is a schematic diagram of the physical architecture of the system 10. The system 10 comprises a server 30 and a plurality of portable devices 13 that may communicate with the server 30. Persons skilled in the art will appreciate that an alternative embodiment of the system 10 may consists of only one portable device 13. Persons skilled in the art will also appreciate that the system 10 may comprise more than server 30 in an alternative embodiment. In this embodiment, each portable device 13 is a smartphone. However, it is envisaged that one or more of the portable devices 13 may not be a smartphone in another embodiment. For example, one of the portable devices 13 may alternatively be a tablet device in an alternative embodiment.

The server 30 is connected to a location database 83 for storing a plurality of location records for associating the durations>of time spent by the person (or persons) associated with the portable device 13 at respective locations, Each location record comprises location data for enabling a determination of the location, and the server 30 may communicate with the location database 83 to retrieve from the location database 83 one or more of the locations stored in the location database 83, It is envisaged that the location records stored in the location database 83 may be stored not only in the location database 83 connected to the server 30 in an alternative embodiment. In particular, in an alternative embodiment, one or more (such as location records that are relevant to a user of a portable device 13, or within a certain distance from a portable device 13) of the location records stored in the location database 83 may—in addition to being stored in the location database—also be stored in each portable device 13 such that the portable device 13 can have access to the location records even if the portable device 13 is not in communication with the server 30.

The server 30 is also connected to a duration database 88 for storing duration data (for example, in the form of a table of durations) corresponding to the durations of time spent by the person associated with the portable device 13 at the respective locations. As indicated above, the durations of time is associated with respective locations by respective location records stored in the location database 83. The server 30 may communicate with the duration database 88 to add duration data to the duration database 88. When duration data is added, the duration of time corresponding to the added duration data is associated with a location of a location record stored in the location database 83. Persons skilled in the art will appreciate that the each database may initially be empty. In particular, the duration database 88 may initially be empty before duration data is added to the duration database 88.

It is envisaged that the location database 83 will typically be updated via the server 30, for example, by an administrator of the system 10 when a new job is received. However, either or both of the location database 83 and the duration database 88 may be modified by other users in an alternative embodiment. In particular, when a new job is created, both the location database 83 and the duration database 88 may be updated by a user of a portable device 13 by way of a location record transmitted from the portable device 13 to the server 30.

Persons skilled in the art will appreciate that each database may be implemented in a variety of ways. For example, the location database 83 may be a job/project masterfile implemented by a web-based or cloud based database. Alternatively, the location database 83 may be a local hard drive implemented at the server 30. Persons skilled in the art will also appreciate that data may be stored in different ways in each database. For example, the plurality of locations stored in the location database 83 may be Global Positioning System (GPS) coordinates in one embodiment. Alternatively, the locations may be in the form of street addresses in another embodiment.

Typically, communication of data between the portable device 13 and the server 30 is via a first communications network in the form of a mobile communication network, and the communication of data between the server 30 and each of the location database 83 and duration database 88 is via a second communications network such as a local area network (LAN). However, it is envisaged that this may not always be the case. For example, the location database 83 may be integrated with the server 30, and data may hence be directly retrieved by the server 30 from the location database 83.

It is envisaged that the system 10 is typically implemented by a plurality of other computing devices in data communication with one another. Examples of such a computing device include a computer server, a desktop personal computer, a portable computer (such as a laptop computer, a notebook computer or a tablet computer), a mobile computing device (such as a smartphone), a programmable circuit etc. Persons skilled in the art will appreciate that the system 10 may be implemented by multiple computing devices such that each computing device implements only a part or parts of the system.

Persons skilled in the art will also appreciate that, the location database 83 and the duration database 88 may be implemented in a single storage device or in separate storage devices.

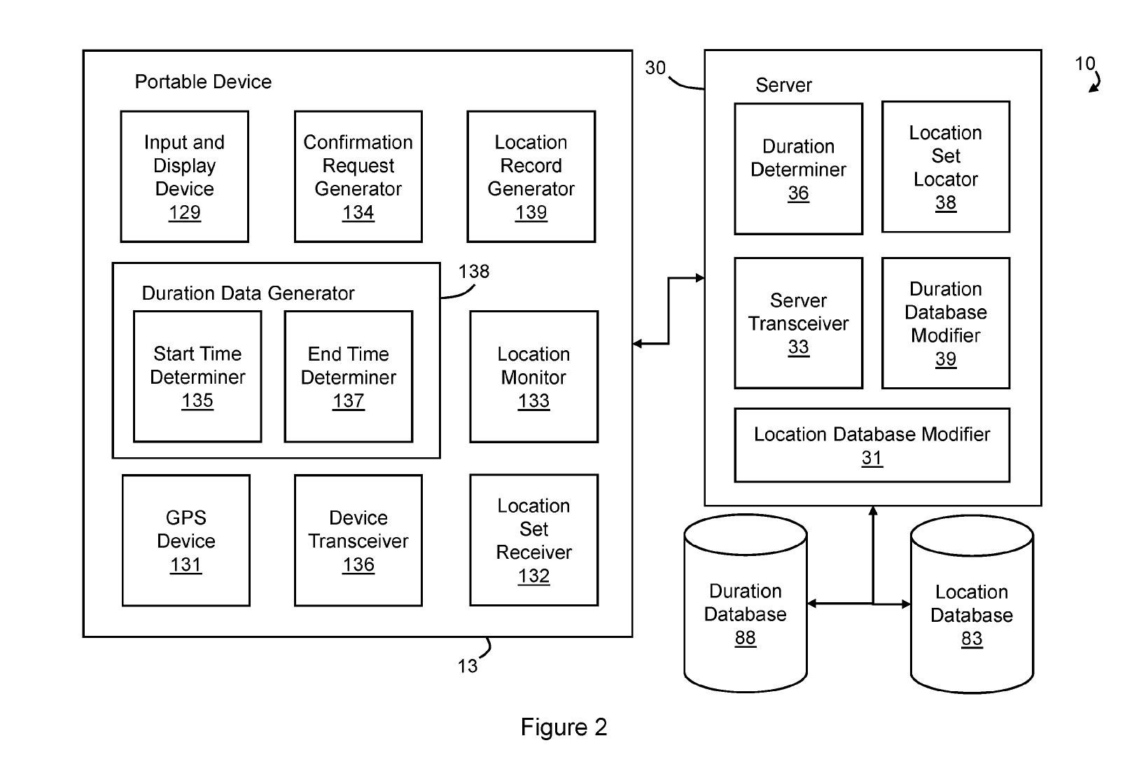

FIG. 2 is a schematic diagram of the functional components of the system 10 of FIG. 1. In FIG. 2, only one of the three portable devices 13 of FIG. 1 is shown. As indicated above, an alternative embodiment of the system 10 may include just one portable device 13 or more than one portable device 13.

As shown in FIG. 2, the portable device 13 comprises a Global Positioning System (GPS) device 131 configured to determine the location or position of the portable device 13. The portable device 13 also includes a transceiver 136 comprising a transmitter for transmitting data to the server 30 and a receiver for receiving data from the server 30. The portable device 13 also comprises a plurality of functional components. It is envisaged that the functional components are typically implemented by a processor of the portable device 13 executing program code and data stored in a memory of the portable device 13. For example, the functional components may be implemented by way of Application Programming interfaces (APIs) configured for implementing a mobile app at a smartphone in one embodiment. However, persons skilled in the art will appreciate that this need not be the case. For example, one or more of the components could be implemented in an alternative manner, for example, as a dedicated circuit.

One of the functional components is a location set determiner in the form of a location set receiver 132. The location set receiver 132 is arranged to control the transmitter of the transceiver 136 to transmit a location set identifier to the server 30, and to control the receiver of the transceiver 136 to receive a set of locations from the location records stored in the location database 83 via the server 30. It is envisaged that the set of locations retrieved from the location database 83 may comprise one or more locations.

In this embodiment, the location set identifier is Unique Device Identifier (UDID). However, it will be appreciated by a person skilled in the art that the identifier may alternatively not be a UDID. For example, the identifier may alternatively be an identifier of the portable device 13 such as a telephone number, or a user identifier such as a username, or a username and a password. Also, it is envisaged that the user identifier may in an embodiment be stored by an application (such as a mobile app) in a memory of the portable device 13, and the user identifier may be automatically transmitted from the portable device 13 to the server 30 automatically after the application is initiated. The user identifier may in an embodiment be transmitted together with additional information such as the date etc. In an embodiment, a set of locations may be continuously or periodically received from the server 30 such that the set of locations determined at the portable device 13 is updated in real-time (or near real-time due to factors such as processing times, transmission latencies etc.).

Another functional component of the portable device 13 is a location monitor 133 arranged to monitor the portable device 13 to (i) determine whether or not a location of the portable device 13 matches any one of the set of locations received from the server 30 and (ii) determine whether or not the portable device 13 is at a location for a duration of time that exceeds a defined duration of time. It is envisaged that, in an alternative embodiment, the location monitor 133 may be arranged to monitor the portable device 13 to perform either only (i) (that is, only (i) but not (ii)) or only (ii) (that is, only (ii) but not (i)).

In this embodiment, the location monitor 133 monitors the portable device 13, by monitoring the location of the portable device 13 determined by the GPS device 131. However, it is envisaged that the location monitor may alternatively monitor a flag that is set (for example, by the server 30) when the portable device 13 is located in one of the set of locations received from the server 30, in an alternative embodiment. In this embodiment, the location of the portable device 13 is continuously (for example, periodically) and actively monitored by the location monitor 133. Thus, time recordal is performed automatically in real-time (or near real-time due to factors such as processing times, transmission latencies etc.). By enabling automatic time recordal in real-time, the system 10 advantageously allows the duration spent by the technician at a job to be billed as quickly as needed after the technician leaves the location at which the job is located.

In this embodiment, the location monitor 133 is arranged to determine whether or not each location is determined by the GPS device 131 (or, in an alternative embodiment, received by the location monitor 133 from the GPS device 131) between defined working days and/or hours which may be set, for example, by an administer of the system 10. The location monitor 133 determines whether or not a location of the portable device 13 matches any one of the set of locations received from the server 30 (that is, above mentioned (i)) and determines whether or not the portable device 13 is at the location for a duration of time that exceeds a defined duration of time (that is, above mentioned (ii)) only upon determining that the location is determined by the GPS device 131 between defined working days and/or hours. It is envisaged however that, in an alternative embodiment, the location monitor 133 may not determine whether or not each location is determined by the GPS device 131 between defined working days and/or hours and that above mentioned (i) and (ii) may be performed irrespective of when the location is determined by the OPS device 131.

In this embodiment, the location monitor 133 determines that the location of the portable device 13 matches the matched location (that is, above mentioned (i)), by comparing the location of the portable device 13 to the set of locations, sequentially one after another, until the location monitor 133 determines that the location of the portable device 13 is within a predetermined distance of the matched location. However, this need not always be the case. For example, in an alternative embodiment, the location monitor 133 may alternatively compare the location of the portable device 13 with each one of the set of locations (that is, all of the locations of the set of locations) in order to determine that the location of the portable device 13 is within a predetermined distance of the matched location. In yet another alternative embodiment, the location monitor 133 may alternatively determine that the location of the portable device 13 matches the matched location, by determining that the portable device 13 is in the same area (for example, at the same street) of the matched location.

In this embodiment, the predetermined distance is a tolerance or site radius (in metres) set by an administrator of the system 10. However, it is envisaged that the predetermined distance may alternatively or additionally be set by a user of the portable device 13, or any other user in another embodiment.

In this embodiment, the location monitor 133 determines whether or not the portable device 13 is at a location for a duration of time that exceeds a predetermined or defined duration of time (that is, above mentioned (ii)), upon determining that the location of the portable device 13 does not match any one of the set of locations received from the server 30.

More specifically, the location monitor 133 determines whether or not the portable device 13 is at a location for a duration of time that exceeds a predetermined or defined duration of time, by performing:

1) A comparison of the location of the portable device 13 at a reference time to the location of the portable device 13 at a subsequent time, in order to determine whether or not the location of the portable device 13 determined at the subsequent time is within the predetermined distance of the location of the portable device 13 determined at the reference time.

2) A calculation of the duration of time between the reference time and the subsequent time, and a comparison of a defined duration of time to the duration of time between the reference time and the subsequent time, in, order to determine whether or not the first time and the second time are separated by at least the defined duration of time.

In this embodiment, the reference time is initially the first time the location of the portable device 13 (as determined by the GPS device 131) does not match any one of the set of locations (that is, the first time as determined by the location monitor 133), and the subsequent time is initially the second time the location of the portable device 13 (as determined by the GPS device 131) does not match any one of the set of locations (that is, the second time as determined by the location monitor 133). The location monitor 133 is arranged to, upon a determination that the location at the reference time is not within the predetermined distance of the location at the subsequent time and a determination that at least the defined duration of time separates the reference time and the subsequent time, replace the reference time with subsequent time, such that the reference time and the location at the reference time used in determining whether or not the portable device 13 is at a location for a duration of time that exceeds a predetermined or defined duration of time are the subsequent time and the location at the subsequent time. Thus, determination by the location monitor 133 of whether or not the portable device 13 is at a location for a duration of time that exceeds the defined duration of time is in respect of the most recent location (that is, the location most recently determined by the GPS device 131) that does not match any one of the set of locations.

The defined duration of time in this embodiment is the minimum duration of time a person associated with the portable device 13 could perform a job or work related activity. However, it is envisaged that the defined duration of time may be some other duration, such as a threshold duration of time. It is also envisaged that the defined duration of time may be variable depending on the activity, the location and/or the person, in an alternative embodiment. In this embodiment, the activity is typically a job or work related activity and hence may be billed to a customer. However, it is envisaged that other forms of activity may be recorded.

The predetermined distance is a tolerance or site radius (in metres) set by the administrator of the system 10. In this embodiment, the predetermined distance used by the location monitor 133 to determine whether or not the portable device 13 is at a location for a duration of time that exceeds a predetermined or defined duration of time (that is, above mentioned (ii)) is the same as the predetermined distance used by the location monitor 133 to determine whether or not the location of the portable device 13 matches any one of the set of locations (that is, above mentioned (i)). However, it is envisaged that different predetermined distances may be used.

The portable device 13 also comprises a location record generator 139 arranged to, generate in a memory of the portable device 13 a new location record for enabling a recordal of a duration of time spent by the person at a location and associating the duration of time spent by the person with the location determined at the first time, upon the location monitor 133 determining that the location at the reference time is within the predetermined distance of the location at the subsequent time and that at least the defined duration of time separates the reference time and the subsequent time.

A duration data generator 135 is used to determine the duration of time spent by the person at a location. The duration data generator 138 comprises a start time determiner 135 and an end time determiner 137.

The start time determiner 135 is arranged to determine the time (that is, a start time) at which a location of the portable device 13 first matches one of the set of locations received from the server 30, that is, when the location monitor 133 first determines that the location of the portable device 13 matches one of the set of locations. The start time determiner 135 does so, by recording the time at which the location monitor 133 first determines that the location matches one of the set of locations received from the server 30. The start time determined by the start time determiner 135 when the location of the portable device 13 first matches one of the set of locations is subsequently transmitted in the form of duration data together with the matched location and the location set identifier by the transmitter of the transceiver 136 from the portable device 13 to the server 30, upon the start time determiner 135 determining the start time. In addition, a status flag may be set to indicate that a duration of time spent by the person associated with the portable device 13 at the matched location is currently in the process of being recorded by the system 10.

The end time determiner 137 is arranged to determine the time (that is, an end time) at which the location of the portable device 13 last matches the matched location (that is, the location of the set of locations that the location monitor 133 determined matches the location of the portable device), that is, the last time the location of the portable device 13 matches the same matched location. The end time determiner 137 does so, by recording the time at which the location monitor 133 last determines that the location matches one of the set of locations received from the server 30. In this respect, it is envisaged that, in some implementations, a recorded start or end time is only an estimation of the true start or end time at which the portable device 13 is at a location (rather than the “true” or “exact” start or end time). For example, it is envisaged that, in an embodiment, the recorded end time may be an estimated end time in the form of the first time it is determined the portable device 13 does not match any one of the set of locations (rather than the last time it is determined that the location matches one of the set of locations). Like with the start time determined by the start time determiner 135 when the location of the portable device 13 first matches one of the set of locations, the end time determined by the end time determiner 137 when the location of the portable device 13 last matches one of the set of locations is subsequently transmitted in the form of duration data together with the matched location and the location set identifier by the transmitter of the transceiver 136 from the portable device 13 to the server 30, upon the end time determiner 137 determining the end time, in addition, the status flag may be reset to indicate that a recordal of a duration of time spent by the person associated with the portable device 13 at the matched location by the system 10 is completed.

The start time determiner 135 is also arranged to determine the time (or a start time) at which the portable device 13 is first at a location that is within a predetermined distance of a location previously determined by the GPS device 131 at the reference time. The start time determiner 135 does so, by recording the time at which the location monitor 133 first determines that the location does not match any one of the set of locations received from the server 30. As indicated above, determination by the location monitor 133 of whether not the portable device 13 is at a location for a duration of time that exceeds the defined duration of time is in respect of the most recent location that does not match any one of the set of locations, and the most recent location is the location determined at the above mentioned reference time. Thus, the time at which the location monitor 133 first determines that the location of the portable device 13 does not match any one of the set of locations is the reference time. In addition, a status flag may be set to indicate that a duration of time spent by the person associated with the portable device 13 at the matched location is currently in the process of being recorded by the system 10.

The end time determiner 137 is also arranged to determine the time (or an end time) at which the portable device 13 is last at a location that is within a predetermined distance of a location previously determined by the GPS device 131 at the reference time. In addition, the status flag may be reset to indicate that a recordal of a duration of time spent by the person associated with the portable device 13 at the matched location by the system 10 is completed.

The portable device 13 also comprises a confirmation request generator 134 arranged to control an input and display device 129 of the portable device 13 to display a request for a confirmation that, the person associated with the portable device is performing an activity at the location (for example, in the form of a pop-up window on a touch screen), upon the duration data generator 138 generating a duration of time (spent by the portable device 133 at a location) that exceeds the defined duration of time. Upon the input and display device 129 receiving the confirmation that the person associated with the portable device is performing the activity at the location (for example, in the form of a touch on the above mentioned pop-up window on the touch screen), the start time determined by the start time determiner 135 when the portable device 13 is first at the location that exceeds the defined duration of time and the end time determined by the end time determiner 137 when the portable device 13 is last at the location that exceeds the defined duration of time are subsequently transmitted together (in the form of duration data) with the location in the form of the location record (that is, the location record generated by the location record generator 139) by the transmitter of the transceiver 136 from the portable device 13 to the server 30, upon the end time determiner 137 determining the end time.

Like with the portable device 13, the server 30 also comprises a transceiver 33 comprising a transmitter for transmitting data and a receiver for receiving data. The server 30 also comprises a number of functional components. As mentioned above in respect of the portable device 13, the functional components are typically implemented by a processor of the server 30 executing program code and data stored in a memory of the server 30. However, persons skilled in the art will appreciate that one or more of the components could be alternatively implemented, for example, by a dedicated circuit.

One of the functional components is a location set locator 36. The location set locator 38 is arranged to control the receiver of the transceiver 33 to receive the location set identifier transmitted by the location set receiver 132 from the portable device 13 to the server for the server to locate a set of locations. The location set locator 38 is arranged to, upon receipt of the location set identifier, locate the set of locations from the plurality of locations stored in the location database 83 based on the received location set identifier, and to control the transmitter of the transceiver 33 to transmit the located set of locations to the portable device 13.

Another one of the functional components implemented by the server 30 is a location database modifier 31 arranged to receive the location record generated by the location record generator 139 of the portable device 13 and transmitted from the portable device 13 to the server 30. The location database modifier 31 is arranged to generate data indicative of the location that exceeds the defined duration of time included in the location record, and to store the generated data in the location database 63 in communication with the server 30.

The server 30 also comprises a duration determiner 36 arranged to control the receiver of the transceiver 33 to receive the start time and the end time transmitted from the portable device 13 to the server 30.

The duration determiner is arranged to, upon receipt of the start time or the end time transmitted together with a matched location, determine the duration of time spent, by the portable device 13 at the matched location from the start time or the end time. In this embodiment, each one of the start time and the end time is transmitted in the form of a record comprising an identifier (such as the location set identifier previously transmitted from the portable device 13 to the server 30) and the matched location to enable the server 30 to identify (i) the portable device 13 that transmitted the start time or the end time and (ii) the location that corresponds to the start time or end time. However, it is envisaged that the start time or end time may not, be transmitted from the portable device 13 to the server 30 in this fashion. For example, in an alternative embodiment, the start time may be transmitted from the portable, device 13 to the server 30 with just the matched location, and the server 30 may be configured to automatically identify the portable device 13 that transmitted the start time from the matched location that was transmitted with the start time.

The duration determiner 36 is also arranged to, upon receipt of the start time and the end time transmitted together with a location that exceeds the defined duration of time, determine the duration of time spent by the portable device 13 at the location from the start time and the end time. As indicated above, the start time and the end time are transmitted together with an identifier (such as the location set identifier previously transmitted from the portable device 13 to the server 30) and the location to enable the server 30 to identify (I) the portable device 13 that transmitted the start time and the end time and (ii) the location that exceeds the defined duration of time.

Another one of the functional components of the server 30 is a duration database modifier 39. The duration database modifier 39 is arranged to generate data indicative of the duration determined by the duration determiner 36, and to store the generated data in the duration database 88 in communication with the server 30.

It is envisaged that some of the functional components implemented by one of the portable device 13 and the server 30 may be alternatively be implemented by the other one of the portable device 13 and the server 30 in an alternative embodiment. For example, in the above embodiment, the duration determiner 36 is implemented by the server 30. In an alternative embodiment, the duration determiner 36 alternatively may be implemented by the portable device 13. In such an embodiment, the duration determiner implemented by the portable device 13 may, upon the end time determiner 137 determining the end time, determine the duration of time spent by the portable device 13 at the matched location from the start time and the end time determined by the start time determiner 135 and the end time determiner 137 respectively. Duration data indicative of the time spent by the portable device 13 at the matched location may then be generated by the duration determiner implemented at the portable device, and then subsequently transmitted by the transmitter of the transceiver 136 of the portable device 13 from the portable device 13 to the server 30.

Also, it is envisaged either one of the portable device 13 or the server 30 may include additional functional components in an alternative embodiment. For example, in an alternative embodiment where the duration data is generated by a duration determiner implemented by the portable device 13, the portable device 13 may also include memory in, the form of a duration data cache for storing the duration data generated by the duration determiner. In such an alternative embodiment, the duration data may be stored in the duration data cache at the same time as when the duration data is transmitted by the transmitter of the transceiver 136 from the portable device 13 to the server 30. Thus, the duration data may be re-transmitted from the portable device 13 to the server 30 if the initial transmission of the duration data is not received at the server 30, for example, when there is a connection failure between the portable device 13 and the server. Alternatively, the duration data may be periodically stored in the duration data cache, and the duration data stored in the duration data cache 139 may only be transmitted at designated times (for example, only at start-up of the mobile app) or circumstances (for example, when the portable device 13 is not located at a matched location) from the portable device 13 to the server 30. That is, synchronization of duration data between the portable device 13 and the server 30 may not be in real-time.

Finally, it is also envisaged that some of the functional components of FIGS. 1 and 2 may not be implemented in an alternative embodiment. For example, in an alternative embodiment, a portable device 13 does not comprise a location record generator 138 and accordingly the portable device 13 does not enable a server 30 to record the duration of time spent by a person at a location that does not match any one of the set of locations received from the server 30.

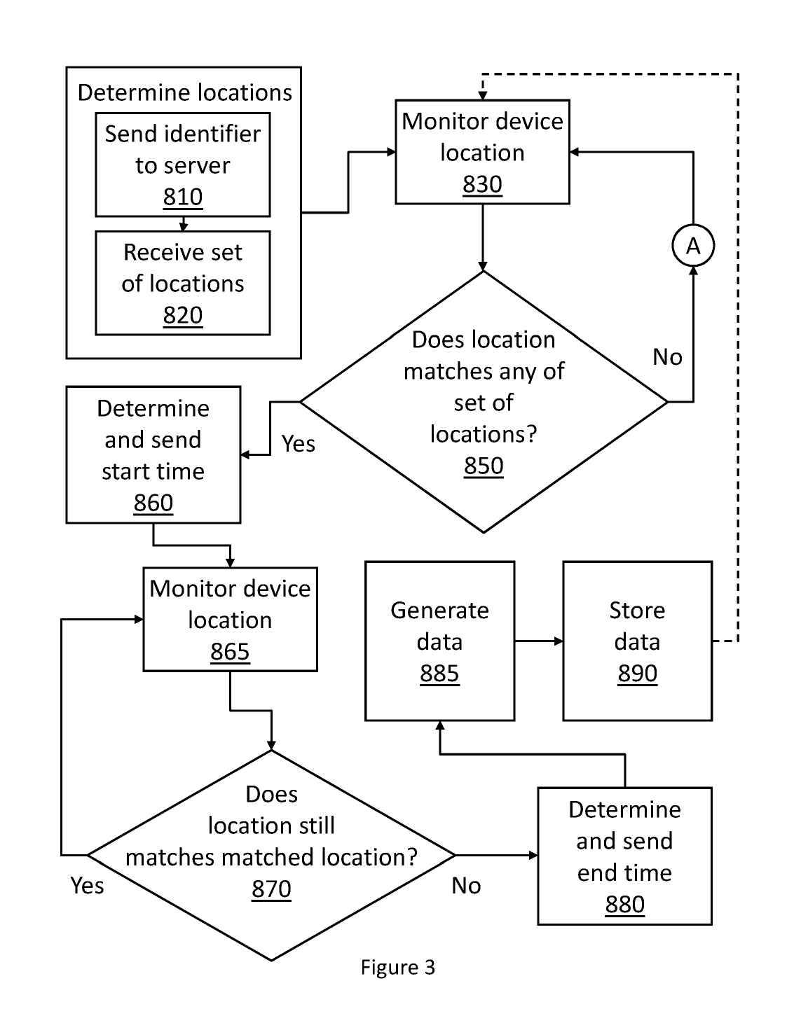

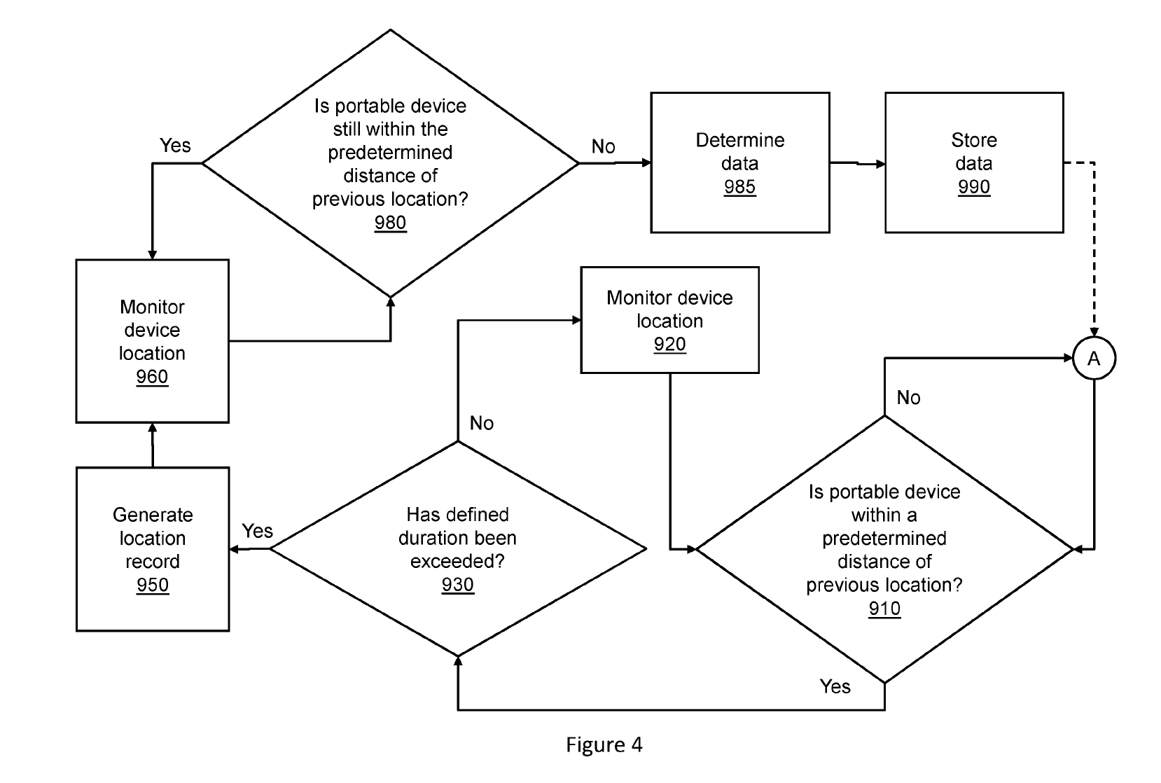

FIGS. 3 and 4 are flow charts illustrating an embodiment of the method for automatic time recordal, as carried out using the system of FIGS. 1 and 2.

Turning first to FIG. 3, at step 810, the location set receiver 132 of the portable device 13 controls the transmitter of the transceiver 136 of the portable device 13 to transmit to the server 30 a location set identifier in the form of a UDID.

The UDID transmitted from the portable device 13 to the server 30 is received by the location set locator 38 of the server 30 via the receiver of the transceiver 33 of the server 30. Upon receipt of the UDID (which as described above could be another form of user identifier in an alternative embodiment), the location set locator 38 of the server 30 locates a set of locations based on the received location set identifier from the plurality of locations stored in the location records of the location database 83 in communication with the server 30. The location set locator 38 then controls the transmitter of the transceiver 33 of the server 30 to transmit the located set of locations to the portable device 13.

The set of locations transmitted from the server 30 to the portable device 13 is received by the location set receiver 132 of portable device 13 via the receiver of the transceiver 136 of the portable device 13 at step 820.

At step 830, the location monitor 133 of the portable device 13 monitors the location of the portable device 13 provided by the OPS device 131 of the portable device 13, and at step 850 determines whether or not the location of the portable device 13 is within a predetermined distance of any one of the set of locations received from the server 30. In this embodiment, the location monitor 133 determines whether or not the location of the portable device 13 is within a predetermined distance of any one of the set of locations, by comparing the location of the portable device 13 to the set of locations, sequentially one after another. However, as described above, it is envisaged that the determination may be carried out in a different way in an alternative embodiment. For example, in an alternative embodiment, the portable device 13 may determine whether or not the location of the portable device 13 is within a predetermined distance of any one of the set of locations, by comparing the location of the portable device 13 to each location of the set of locations.

If the location of the portable device 13 is not within a predetermined distance of any one of the set of locations received from the server 30 at step 850, the method proceeds as illustrated in FIG. 4.

Otherwise, if it is determined that the location of the portable device 13 is within a predetermined distance of one of the set of locations received from the server 30 at step 850, the start time determiner 135 determines a start time at which the location of the portable device 13 is first within a predetermined distance of the matched distance at step 860. The start time determined by the start time determiner 135 is then transmitted from the portable device 13 to the server 30.

At step 865, the location monitor 133 of the portable device 13 continues to monitor the location of the portable device 13 provided by the OPS device 131 of the portable device 13. If it is determined that the location of the portable device 13 is still within a predetermined distance of the matched location at, step 870, the location monitor 133 continues to monitor the location of the portable device 13 determined by the GPS device 131 of the portable device 13 at step 865.

Otherwise, if it is determined that the location of the portable device 13 is no longer within a predetermined distance of the matched location at step 870, the end time determiner 137 determines an end time at which the location of the portable device 13 is last within a predetermined distance of the matched distance at step 880. The end time determined by the end time determiner 137 is then transmitted from the portable device 13 to the server 30.

At step 885, upon receipt of the start time and the end time from the portable device 13, the duration determiner 36 of the server 30 determines the duration of time spent by the portable device 13 at the matched location from the start time and the end time, and the duration database modifier 39 generates duration data indicative of the duration of time spent by the portable device 13 at the matched location.

At step 890, the duration data generated by the duration database modifier 39 is then stored in the duration database 88.

Referring now to FIG. 4, upon determining that the location of the portable device 13 is not within a predetermined distance of any one of the set of locations received from the server 30 at step 850 of FIG. 3 (as indicated above), the location monitor 133 determines whether or not the portable device 13 is at its location for a duration of time that exceeds a defined duration of time. Firstly, at step 910, the location monitor 133 determines whether or not the portable device 13 is within a predetermined distance of a location previously determined by the GPS device 131. The location monitor 133 does so by determining whether or not the portable device 13 is within a predetermined distance of a location previously determined by the GPS device 131.

If the location monitor 133 determines that the portable device 13 is not within the predetermined distance of the previously determined location at step 910, the method reverts back to step 830 of FIG. 3.

Otherwise, if the location monitor 133 determines that the portable device 13 is within the predetermined distance of the previously determined location, the location monitor 133 determines whether or not the portable device 13 is within the predetermined distance of the previously determined location for a duration of time that exceeds the defined duration of time at step 930. More specifically, the start time determiner 135 of the duration data generator 138 of the portable device 13 first determines the time (that is, a start time) at which the portable device 13 is first at a location that is within a predetermined distance of a location previously determined by the OPS device 131 at the reference time. Then, the end time determiner 137 of the duration data generator 138 of the portable device 13 determines the time (that is, an end time) at which the portable device 13 is last at a location that is within a predetermined distance of a location previously determined by the OPS device 131 at the reference time. The duration of time for which the portable device 13 is at the location is then determined based on the determined start time and the determined end time, and the duration of time is then compared against the defined duration to determine whether or not the portable device 13 is at the location for a duration of time that exceeds the defined duration.

If the location monitor 133 determines that the portable device 13 is within the predetermined distance of the previously determined location for a duration of time that does not exceed the defined duration of time at step 930, the location monitor 133 continues to monitor the portable device at step 920 in order to determine whether or not the portable device 13 is within the predetermined distance of the previously determined location at step 910. As indicated above, at step 910, the method reverts back to step 830 of FIG. 3 if the location monitor 133 determines that the portable device 13 is not within the predetermined distance of the previously determined location.

Otherwise, if the location monitor 133 determines that the portable device 13 is within the predetermined distance of the previously determined location for a duration of time that exceeds the defined duration of time at step 930, the location record generator 139 of the portable device 13 generates a location record in a memory of the portable device 13 for enabling a recordal of a duration of time spent by the person at the location and associating the duration of time spent by the person with the location at step 950.

At steps 960 and 980, the location monitor 133 continues to monitor the portable device 13, and to determine whether or not the location of the portable device 13 is still within the predetermined distance of the previous location. If so, the location monitor 133 continues to monitor the portable device 13 at step 960 until the location monitor 133 determines that the location of the portable device 13 is no longer within the predetermined distance of the previous location at step 980.

At step 985, the input and display device 129 of the portable device 13 is controlled by the confirmation request generator 134 of the portable device 13 to display a request for a confirmation that the person associated with the portable device is performing an activity at the location. It is envisaged that the confirmation may be received in different ways. For example, in one embodiment, the confirmation may be received upon the input and display device 129 receiving a touch input from a user of the portable device 13. Upon receiving the confirmation via the input and display device 129, the location record comprising the start time determined by the start time determiner 135 when the portable device 13 is first at the location that exceeds the defined duration of time, the end time determined by the end time determiner 137 when the portable device 13 is last at the location that exceeds the defined duration of time are transmitted, the location that exceeds the defined duration of time, and the location set identifier is transmitted by the transmitter of the transceiver 136 of the portable device 13 from the portable device 13 to the server 30.

At step 990, the location database modifier 31 of the server 30 generates data indicative of the location that exceeds the defined duration of time included in the location record, and stores the generated data in the location database 83. Also, the duration determiner 36 determines the duration of time spent by the portable device 13 at the location from the start time and the end time included in the location record, and the duration database modifier 39 generates data indicative of the duration determined by the duration determiner 36, and stores the generated data in the duration database 88.

### EXAMPLE

In this example, the system 10 for automatic time recordal comprises a portable device 13 in the form of a smartphone (such as an Apple iPhone) that is used by a user such as a technician or a staff member, and a server 30 in the form of a project accounting system that is controlled by an administrator. In this example, the location database 83 is a job/project rnasterfile implemented by a web-based database (“Web DB”).

A software application or mobile app is installed or loaded into a memory of the smartphone 13. In use, the smartphone 13 is configured to implement a number of software components by way of APIs The APIs include the following pre-programmed Apple APIs:

1) Location APIs
a) These APIs are used for determining GPS coordinates, which includes latitude and longitude.
b) These APIs are also used for reverse geocoding, which may be used to determine a street address using location coordinates.

2) UlKit API
a) This API is used for creating a list view.
b) This API is also used for creating text fields, buttons and a navigation bar. 3) MapKit API
a) This API is used for displaying jobs in a map view.

4) Coredata API
a) This API is used for implementing local storage in the mobile app, such that a technician may use the mobile app when there is no available network connectivity.

5) Foundation API
a) A HTTP API is used for communications with mobile application backend services.
b) A Date Time API is used for processing technician working hours, job start and end times and GPS coordinate creation time during location processing.

In this example, three of the above APIs (specifically, 1) Location APIs, 3) MapKit API and 5)b) Date Time API) are used for automatic time recordal of existing jobs (that is, the jobs corresponding to the locations stored in the location database). Two of the APIs (specifically, 1) Location APIs and 5)b) Date Time API) are used for automatic time recordal of new jobs In addition to the above pre-programmed APIs, the smartphone 13 is also configured to implement the following custom APIs:

1) Identify Technician

This API is used to identify the technician at the project accounting system 30. In use, a UDID is generated by the mobile app. The UDID is then sent to the project accounting system 30 in a request for technician details. If the sent UDID is found on the project accounting system 30, technician details are sent to the smartphone 13. This enables the mobile app implemented by the smartphone 13 to access other features (as described below). Otherwise, if the sent UDID is not found on the project accounting system 30, an exception prompt is displayed, for example, by sending an email to an administrator, in order to register the sent UDID on the project accounting system 30. 2) Sync Job By Technician

This API is used to retrieve a set of locations in the form of available jobs for a technician from the project accounting system 30. Usage of this API requires a UDID. In use, the project accounting system 30 returns a success status code with available job objects when a UDID is found. Otherwise, a failure status code is returned in response. Usage of this API may include setting a predetermined distance in the form of the radius of a job site zone for each available job. 3) Create New Job

If any new job location is accepted by a technician, this API is used, by the mobile app to create a new job location on the project accounting system 30. Usage of this API requires a UDID and new job details (such as Name, Street Address, Suburb, State, Postcode, Latitude and Longitude, Start date). In use, the project accounting system 30 returns a success status code with a server generated job id, or alternatively a failure status code, in response to a request to create the new job. When the success status code is returned, the new job location is added to the set of locations stored in the project accounting system 30.

4) Sync Job Details

This API sends to the project accounting system 30 a transfer of data to indicate the start date and time or end date and time of work performed on site by a technician for a job. Usage of this API requires a UDID, job id and either the start date and time or end date and time. In use, the project accounting system 30 returns a success status code or alternatively a failure status code, in response to the request sent to the project accounting system 30. This API may also be used to capture the first start date and time and end date and time from sites created directly from the smartphone 30 (as described at Custom API 3) Create New Job).

Three of the above custom APIs (specifically, 1) Identify Technician, 2) Sync Job By Technician and 4) Sync Job Details) are primarily used for GPS related automatic time recordal. Also, all of the custom APIs (specifically, 1) Identify Technician, 2) Sync Job By Technician 3) Create New Job and 4) Sync Job Details) may be used for automatic time recordal of new jobs, in particular, for capturing first start date and time and end date and time for sites created directly from the smartphone 13.

It will be appreciated that the pre-programmed APIs and the custom APIs may provide additional functionalities not described above. For example, the pre-programmed Location API may send a notification to the mobile app when new GPS coordinates are available, and the mobile app may process any received GPS events and store the processed GPS events in local storage with date and time on which it received.

In addition to the above APIs, the mobile app is also configured to implement a number of threads of execution including:

1) Process location thread that is used for processing focal storage location events, according to custom logic which determines technician location at any point of time, and update start and end dates and times on any jobs performed.

2) Job Sync thread that is used to sync all technician jobs available on backend server 30, which is created or modified by administrators or added by Custom API 3) create new job.

3) Get Job Street Address thread that is used to locate job street address by using a reverse geocoding API. A new job can be created by the smartphone 13 using a new job location's GPS coordinates, and the project accounting system 30 receives the address from the mobile app, when the smartphone 13 syncs with the project accounting system 30.

4) Job Detail Sync thread that is used for syncing job details (including technician start date and time and end date and time).

According to an embodiment of the method for automatic time record, the smartphone 13 and/or the project accounting system 30 performs the following steps:

1) The smartphone 13 creates one or more records, each record containing a technician identifier, record date, record time and a valid GPS co-ordinate (longitude and latitude). Records are stored in chronological order based on record date and record time.

Do the record date and the record time read on the smartphone 13 satisfy technician working days and hours stored on the project accounting system 30?

2) If the answer to 1) is YES, then is there any active job on the smartphone 13?
a) If NO active job found at 2), then is the distance between the GPS coordinate of the record currently being processed by the smartphone 13, from any of the GPS co-ordinates stored on the set of job/site locations held on server 30 less than an adjustable default job location radius of 400 meters?
   i) If the answer to 2)a) is YES, then make this job active on smartphone 13, and log an entry by sending this record's technician identifier, record date and time as the START date and START time to the project accounting system 30, for the identified technician and for this job. The job is determined based on the GPS co-ordinate from the record being processed matching, (within adjustable tolerance) a GPS co-ordinate from the set of job locations from the project accounting system, held at server 30. Processing for this record is complete and move to process the next record.
   ii) If the answer to 2)a) is NO, then is there any stored record for the generation of a potential new job site location?
      (1) If the answer to 2)a)ii) is YES, then calculate the distance between the GPS coordinate of the record being processed and the stored GPS coordinate, from the stored record, for a potential new job site location.
      Is the calculated distance less than an adjustable default job tolerance of a 400 metre radius?
         (a) If the answer to 2)a)ii)1) is YES, then processing of this record is complete and move to process the next record.
         (b) If the answer to 2)a)ii)1) is NO, then calculate the time elapsed between this record's create date and create time and the stored potential new job location record stored date and stored time.
         Is the calculated time elapsed greater than an adjustable potential new job elapsed time of 20 mins? (i) If the answer to 2)a)ii)1)b) is YES, then create a new job user prompt, based on stored record data, on smartphone 13 and await user response. Store and hold this record's data far generation of another potential new job location and move to process the next record. (ii) If the answer to 2)a)ii)1)b) is NO, then delete the most recently stored potential new job location record and replace stored data with this record's data. This record's GPS co-ordinate, date and time reading are the new reference point for the generation of a potential new job location. Move to process the next record.
      (2) If the answer to 2)a)ii) is NO, then store and hold this record's data for generation of a potential new job location and move to process the next record.
b) If YES, an active job is found from 2), then is the distance between the GPS coordinate of the record being processed, by the smartphone 13, from the GPS coordinate of the active job, stored as the site location on the project accounting system Server 30, less than an adjustable default job location tolerance (being a radius of 400 metres)?
   i) If the answer to 2)a) is YES, then processing of his record is complete and move to process the next record.
   ii) If the answer to 2)a) is NO, then the job previously set as active is set to an inactive status. Further, log an entry by sending this record's technician identifier, record date and record time as the END date and END time to the project accounting system 30, for the identified technician and for this job.
   Further, delete the most recently stored potential new job location record and replace stored data with this record's data, as a potential new job location. Move to process the next record.

3) If the answer to 1) is NO, then is there any record stored for generation of a potential new job location?
i) If the answer to 3) is YES, then calculate the time elapsed between technician working end time, held on server 30, and the latest stored potential new job site location record. Is the elapsed time greater than an adjustable potential new job elapsed time of 30 mins?
   ) if the answer to 3)a) is YES, then create a new job prompt on Smartphone 13, using data from the stored record and await user response. End of processing for this record.
   ii) If the answer to 3)a) is NO, then end processing.
b) If the answer to 3) is NO, then ignore this record and move to process the next record.

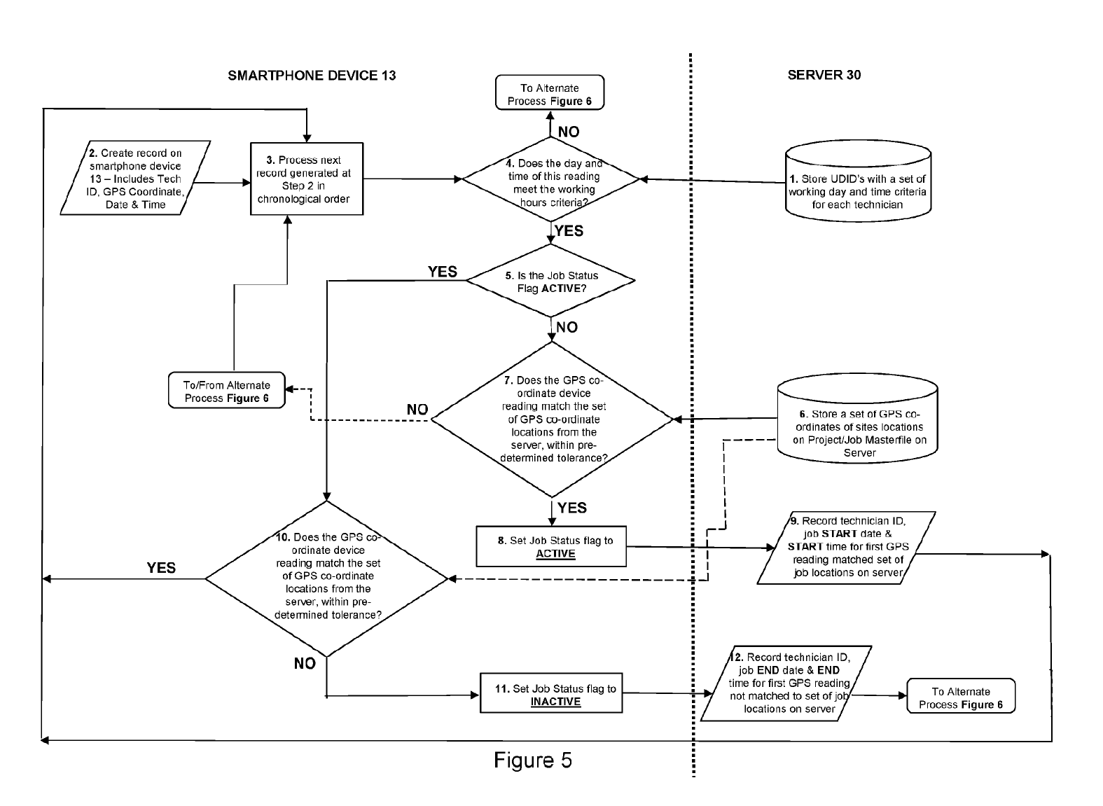

FIG. 5 is a flow diagram of an alternative embodiment of the method for automatic time recordal, performed by smartphone 13 and the project accounting system 30.

At step 1, a set of technician device identifiers with related valid working days and times s stored on the project accounting system 30 for each technician.

At step 2, the smartphone 13 continuously monitors and generates records in real time, each record comprising a technician device identifier, a GPS co-ordinate, a date and a time.

At step 3, the records generated (each record comprising a technician device identifier, a GPS co-ordinate, a date and a time) by the smartphone 13 are processed in chronological order.

At step 4, the technician identifier, the date and the time of each record generated at step 2 is compared to the set of technician identifiers and related valid working days and times stored on the project accounting system 30 at step 1.

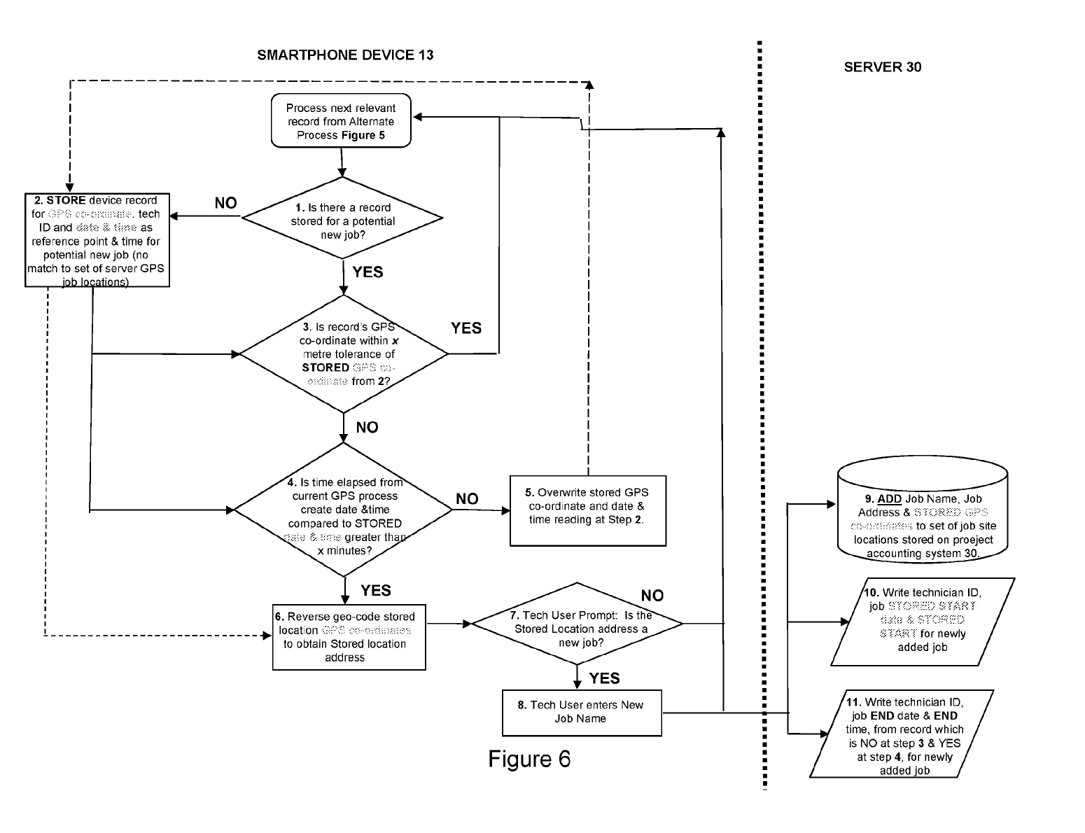

If the date and the time of a record meet the working day and time criteria (that is, are within the set of valid working days and times stored in the project accounting system 30), then the record is further processed at step 5. Otherwise, the record is further processed according to an alternative automatic time recordal method for creating new jobs described in FIG. 6.

At step 5, the device determines whether there is currently a job designated as active. If there is not a job designated as active (status of INACTIVE), then the record is processed at step 7, otherwise the record is processed at step 10.

A job is designated as active, when a record is processed at step 3, meets the working day and time criteria (as described above) at step 4 and the GPS co-ordinate of the record matches, within tolerance, one of the set of site locations (which are in the form of GPS co-ordinates) stored on the project accounting system 30 (as described in further detail below) at step 7.

At step 6, each one (in the form of GPS coordinate) of a plurality of site and/or customer locations are stored in the job/project masterfile on the project accounting system 30.

At step 7, the GPS coordinate of each record generated by the smartphone 13 at step 2 is compared to the GPS coordinates of the set of site locations stored on the project and/or job rnasterfile on the project accounting system 30 at step 6. In this example, the GPS coordinates match within tolerance (which in this example is in the form of a predetermined distance, or number of metres or degrees of one of the GPS coordinates of the set of locations read from the project, and/or job masterfile). The tolerance is set by an administrator of the project accounting system 30.

As indicated above, if the GPS coordinate of a record generated by the smartphone 13 matches one of GPS coordinates of the set of site locations read from the project and/or job masterfile in the project accounting system 30 at step 6, within tolerance, a job (or the status of the job) corresponding to the matching site location is set to active on the smartphone 13 at step 8.

Further, at step 9, the technician device identifier, the date and the time of the matching record as recorded at step 2, are automatically recorded as the START date and the START time corresponding to the matching site location of the set of site locations stored on the project accounting system 30 at step 6.

Otherwise, if the GPS coordinate of a record captured at step 2 does not match the GPS coordinates of the set of site read from the project and/or job masterfile on the project accounting system 30 at step 7, the record is further processed to determine whether a new job is to be created according to the alternate process described in FIG. 6.

If, as noted above in respect to step 5, there is already a job designated as active (status of ACTIVE), then the record is processed at step 10.

At step 10, the GPS coordinate of each record, as recorded by the smartphone 13 at step 2, is compared to the GPS coordinate of the active job site location of the set of site locations stored on the project and/or job masterfile on the project accounting system 30 at step 6. In this example, the GPS coordinates match within tolerance (that is, a predetermined distance, or number of metres or degrees of one of the GPS coordinates of the set of locations read from the project accounting system 30). The tolerance is set by the administrator.

If, the GPS co-ordinate of the record matches, within tolerance, the GPS co-ordinate of the active site of the set of site locations stored on the project accounting system 30 at step 6, processing of the record is complete and another record (including technician ID, GPS co-ordinate, date and time) is processed at step 3.

Otherwise, if there is no longer a match of the GPS coordinate of the record with the GPS coordinate of the active job, the job status flag is set to INACTIVE at the smartphone 13 at step 11.

Further, at step 12, the technician device identifier, the date and the time of the record as recorded at step 2 is automatically recorded as the END date and the END time corresponding to the matching site location of the active job by the project accounting system 30. The technician device identifier, the END date and the END time are matched to a particular site location of the set of site locations stored on the project accounting system 30 at step 6 based on a match of GPS co-ordinates.

As will be described below in respect of FIG. 6, the technician device identifier, the GPS co-ordinate, the date and the time are stored at Step 1 of FIG. 6 according to the alternate automatic time recordal method for creating new jobs.

It is envisaged that billing or cost rates can be applied upon recordal of the technician device identifier, the END date and the END time at step 12, based on the technician device identifier, the START date, the START time, the END date and the END time recorded by the project accounting system 30 at steps 9 and 12. This allows for billing of labour costs to customers (for example, on a variable, hourly, or cost plus jobs basis), or for providing job labour costing (for example, as a fixed Price, quoted, or lump sum jobs basis).

FIG. 6 is a flow diagram of an alternative embodiment of the method for automatic time recordal of new jobs, performed by the smartphone 13 and the project, accounting system 30.

This alternate embodiment is designed to ensure that all potential revenue in respect of the technician (or tradesperson or service provider) are captured, particularly, where jobs or services are arranged on an emergency basis or short notice, or where full administrative support may not be possible or available.

This alternate embodiment processes records where there is no active job on the smartphone 13 (or for a record when the job status flag is inactive, as shown in FIG. 5). Therefore, it relates to records where there is no match, within tolerance, between the GPS co-ordinate of a record recorded from the technician's smartphone 13 and the GPS co-ordinates of any one of the set of site locations stored on the project accounting system 30. As with the embodiment of FIG. 5, records are processed in chronological order in this alternative embodiment.

At step 1, the smartphone 13 determines whether there is a record currently being stored as a reference point and time for a particular technician identifier in relation to a potential new job. In practice this might be the first record which satisfies the work day and time criteria of a given work day or a record which makes a job status inactive, as described at FIG. 5 step 11.

At step 2, if there is no reference record being stored as a potential new job this record's technician identifier, GPS coordinate, date and time are stored as the reference point and time for a potential new job. Otherwise, if there is an existing stored reference record, the record undergoes further processing at Step 3.

At step 3, a calculation is performed to determine the distance between the GPS co-ordinate of the current record and the GPS co-ordinate from the potential new job reference record stored at step 2.

If the calculated distance is within a predetermined distance or tolerance, for example 400 metres of the stored reference record at step 2, processing of this record is complete and the next relevant record for creating new jobs is retrieved for processing.

Otherwise, the record undergoes further processing at step 4. A calculation is performed to determine the time elapsed at this potential new job location. The date and time of the record currently being processed is compared to the date and time of the reference record being stored as a potential new job location at step 2.

If the time elapsed, is less than 20 minutes (or the defined duration of time), the existing stored potential new job data from Step 2 is deleted. The data (the technician ID, GPS coordinate, date and time) from the current record is stored as the new reference point and time for a potential new job location at step 5. Further, the next relevant record for creating new jobs is retrieved for processing.

However if at step 4, the time elapsed, is greater than or equal to 20 minutes (or the defined duration of time), the smartphone 13 takes the GPS co-ordinate stored at step 2 and determines the potential new job location's street address and suburb. This process is represented at step 6.

At step 7, the technician receives a prompt on the smartphone 13, as to whether the potential new job's street address and suburb determined at step 6 and time elapsed calculated at step 4 relate to work at a new jab site. There can be multiple potential new jobs queued awaiting a technician's response. Regardless of the response, the next relevant record for creating new jobs is retrieved for processing.

If the technician accepts the new job prompt, the user receives a further prompt on the portable device 13 at step 8, to input a job name

At step 9, on input of the job name by the technician, the job name, the GPS co-ordinate stored from step 2 and the street address and suburb determined at step 6, are added as a new unique job location to the set of stored job locations held on the project accounting system 30.

Further, at step 10, the technician identifier and date and time of the record stored at step 2 are logged as the technician identifier, START date and START time for this newly created job on the job accounting system 30.

Further, at step 11, the technician identifier and date and time of the record which triggers the new job prompt at step 7, are logged as the technician identifier, END date and END time for this newly created job on the project accounting system 30.

As with FIG. 5, billing or cost rates can then be applied, based on the technician identifier, start date and time combination and end date and time combination by the project accounting system 30 for billing labour to customers (for example, on a variable, hourly, cost plus jobs basis) or for providing job labour costing (for example, as a fixed Price, quoted, or lump sum jobs basis).

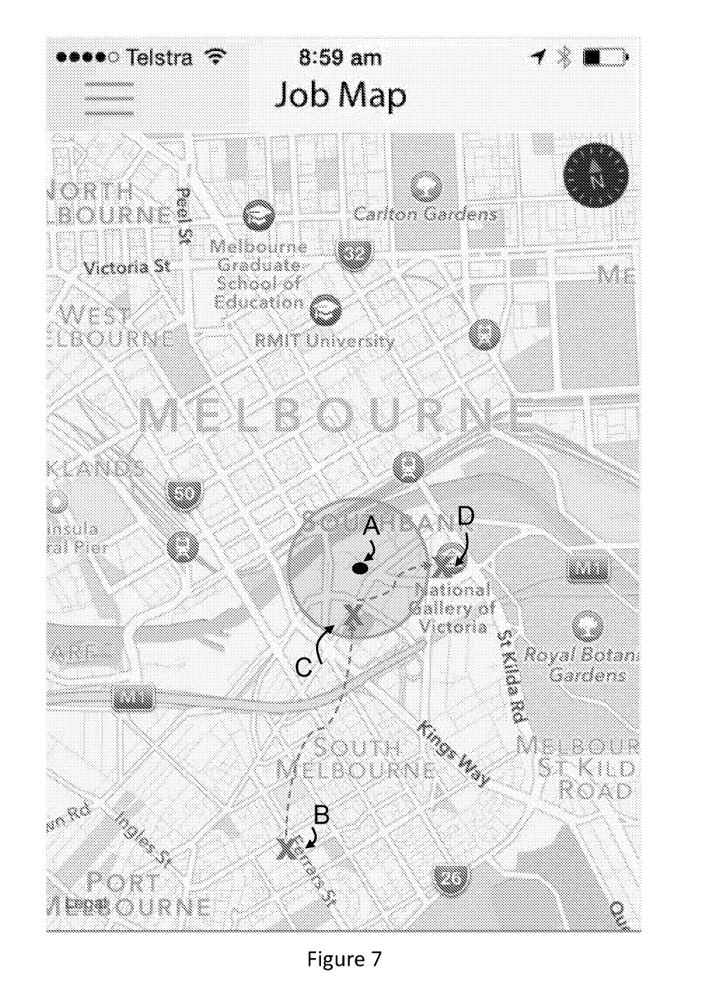

FIG. 7 is a screenshot of the display of a portable device 13 showing a map and the movement of a technician firstly from outside an area (“job zone”) around a GPS location of a job to being within the job zone, and then from being within a job zone to outside the job zone. In the figure, the job location, as held on the project accounting system 30, is indicated by the black dot at Position A and the job zone is indicated by the purple shaded area around the job location.

Firstly, when the technician is outside the job zone at position B, custom API 2) Sync Job by Technician continually syncs a set of GPS locations of current jobs or sites corresponding to the technician in the local storage of the portable device 13 from the plurality of GPS locations stored in the web DB via the project accounting system 30 to the portable device 13. Also, one or more of the jobs is displayed by the portable device 13 to the technician via custom API 1) Identify Technician via UDID.

Then, pre-programmed API 1) Location is used to track the location or GPS coordinates of the portable device 13. Also, a determination as to whether the current time is within working hours previously determined is continually made via custom API 2) Sync Job by Technician.

Upon a determination that the current time is within the working hours, a determination as to whether there is an active job on local storage is made. At this point, there is no active job on local storage. In addition to determining whether there is an active job on local storage, a determination as to whether the portable device 13 is within 400 metres of an active job is made. To make the determination, a job zone radius was passed by Custom API 2) Sync job by Technician.

As the technician is outside the job zone, a determination that the portable device 13 is not within 400 metres of an active job is made, and the record of the portable device 13, (including technician identifier, GPS coordinate, date and time) is stored for determining whether or not a new job is to be created based on the next one or more record processed of the portable device 13.

When the technician moves into the job zone at position C, custom API 2) Sync Job by Technician continues to continually sync the set of GPS locations in the local storage of the portable device 13. Also, a determination as to whether the current time is within working hours previously determined is continually made via custom API 2) Sync Job by Technician, and if it is determined that the current time is within the working hours, a determination as to whether there an active job on local storage is continually made.

At this point, if it is determined that the current time is still within the working hours. As the technician has just moved within 400 metres of a job, there is yet to be an active job on local storage. However, as the technician is now within the job zone, a determination that the portable device 13 is within 400 metres of the location of an available job stored on the project accounting system 30. Custom API 4) Sync Job Details is used to indicate that there is now an ACTIVE job in local storage. Further to recognise the ENTRY to a job zone, the data from the portable device 13 record will be used to log a record in respect of the particular job site, technician identifier, the START date and the START time in the web DB.

When the technician remains in the job zone as indicated by the purple shaded area, custom API 2) Sync Job by Technician continues to continually sync the set of OPS locations in the local storage of the portable device 13. Also, a determination that the current time is within working hours previously determined via custom API 2) Sync Job by Technician is continually made, and a determination that there is an ACTIVE job on local storage is continually made. Furthermore, as the technician is still within 400 metres of a stored job location on the project accounting system 30, a determination that the portable device 13 is within 400 metres of an ACTIVE job is continually made.

When the technician moves out of the job zone at position D, a determination that the portable device 13 is no longer within 400 metres of the active job location as stored on the project accounting system 30 is made. After a determination that there is an active job on local storage is made, custom API 4) Sync Job Details is used to indicate that there is no longer an active job (for example, by marking a job as inactive) in local storage on smartphone 13. Further to recognise the technician exiting from a job zone, the data from the portable device 13 record will be used to log a record in respect of the particular job site, technician identifier, the END date and the END time in the web DB. In this case, this record of the portable device 13 is stored for determining whether or not a new job is to be created based on the next one or more records of the portable device 13.

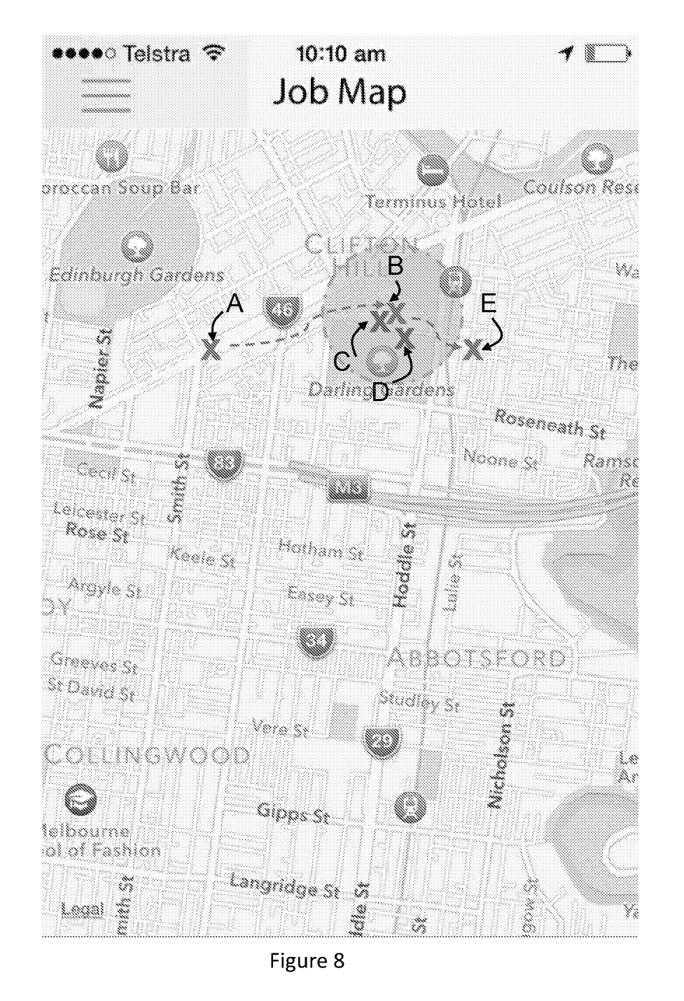

FIG. 8 is a screenshot of the display of the portable device 13 showing a map and the movement of a technician. FIG. 8 illustrates the creation of a new job site directly from the portable device 13. In this example there are no matching “job zones” held on the set of job locations on the project accounting system 30, prior to the technician arriving to the locale displayed on the FIG. 8 map or during the technicians visit to the locale displayed on the FIG. 8 map.

The technician is outside of any job zone at position A, custom API 2) Sync Job by Technician continually syncs a set of GPS locations of current jobs or sites corresponding to the technician, to the local storage of the portable device 13 from the plurality of GPS locations stored in the web DB via the project accounting system 30. In this instance, the project accounting system 30 does not hold a location, amongst the set of locations, which corresponds to the area displayed on the job map in FIG. 8.

In this example, the technician's first reading for a given working day and time, as defined on the project accounting system 30, occurs at position A. Custom API 3) Create New Job, will determine that there is no record stored as a reference record for a potential new job. Therefore, custom API 3) Create New Job will then store the record in relation to Position A, as a reference record for a potential new job. The reference record relating to position A, will include data such as the technician Identifier, GPS coordinate, date and time. Processing in relation to the record at position A is now complete and custom API 3) Create New Job retrieves and begins to process the next relevant record.

In FIG. 8, the technician moves from position A to position B via motor vehicle. A further record (also including the technician ID, GPS coordinate, date and time), in relation to position B, is created and processed by the portable device 13. As the record relating to position B is outside of the set of “job zones” held by the set of locations held on the project accounting system 30, it will be processed by custom API 3) Create New Job.

Custom API 3) Create New Job determines that a record, being in relation to position A, is already stored as a reference record for a potential new job. Custom API 3) Create New Job then compares the record relating to position B, to the reference record stored for a potential new job, being position A.

Firstly, the distance between the GPS coordinate from the record at position B and the GPS coordinate from the stored reference record at position A, is calculated. In this example, the distance between position B and position A is determined to be greater than, a default tolerance of 400 metres. As the distance between position B and the reference position A is greater than 400 metres, there may be a potential new job location at position A. Therefore, the record in relation to position B undergoes further processing.

Custom API 3) Create New Job then compares the time on the record in relation to position B, with the time on the stored reference record relating to position A, to calculate an elapsed time. In this example, the technician has moved between position A and position B by motor vehicle in less than 20 minutes. As the technician has moved from position A to position B in less than a default elapsed time tolerance (that is, a defined duration) of 20 minutes, custom API 3) Create New Job makes a determination that there is no potential new job site at position A. Further, the record in relation to position B, replaces the stored reference record in relation to position A as the new stored reference record for a potential new job. Processing of the record at position B is now complete; and the next relevant record is retrieved for processing.

In FIG. 8, the technician then spends some time working, in and around Position B. Custom API 3) Create New Job processes, in chronological order, the records in relation to position C and position D. As a stored reference record exists (stored reference record relating to position B), a comparison is made of the record from position C to the stored reference record in relation to position B, in relation to a potential new job site. In this instance, the GPS coordinate of the record at position C, is calculated to be within 400 metres (that is, within the default tolerance or the predetermined distance) of the GPS coordinate of the stored reference record at position B. The stored reference record remains as the record relating to position B, therefore position B remains as a potential new job location. Processing of the record relating to position C is now complete; and the next relevant record is retrieved for processing,

As a stored reference record already exists for a potential new job location (record relating to position B), custom API 3) Create New Job compares between the record from position D to the stored reference record in relation to position B. In this instance, the GPS coordinate of the record at Position D, is calculated or determined to be within 400 metres (that is, within the default tolerance or the predetermined distance) of the GPS coordinate of the stored reference record at position B. The stored reference record remains as the record relating to position B and processing of the record at position D is now complete. It is envisaged that records more than those relating to position C and position U may be processed in the same manner. Processing of the record relating to position D is now complete; and the next relevant record is retrieved for processing,

In FIG. 8, the technician then departs a job site located at, or close to position B, by motor vehicle. It is assumed the technician has spent a number of hours completing work. As a stored reference record exists (record relating to position B), custom API 3) Create New Job compares the reading of the record at position E to the stored reference record relating to position B.

Firstly, the distance between the GPS coordinate from the record at position E and the GPS coordinate from the stored reference record at position B, is calculated. In this instance, the distance between position E and position B is determined to be greater than, the default tolerance or the predetermined distance of 400 metres. It can be noted, from FIG. 8, that position E is the first location reading outside of the purple shaded area. The purple shaded area indicates a “potential new job zone” being a 400 metre radius from the stored reference record location, at position B. As the distance calculated is greater than, the default tolerance of 400 metres, the record relating to position E undergoes further processing to determine if there is a potential new job location.

Custom API 3) Create New Job then compares the time on the record in relation to position E, with the time on the stored reference record relating to position B, to calculate an elapsed time. As noted above, in this example, we are assuming that the technician has spent a number of hours at or close to position B, performing work. Therefore, the time reading on the record relating to position E compared to the time reading on the stored reference record relating to position B, will indicate a time elapsed of greater than or equal to, a default elapsed time of 20 minutes. As the technician has moved from position B to position E (outside “potential new job zone”) is more than the default elapsed time (that is, the defined duration) of 20 minutes, custom API 3) Create New Job makes the determination that there is a potential new job site at position B.

On determination that a potential new job exists, custom API 3) Create New job will store the record in relation to position E as a new reference record for a potential new job. Processing of the record relating to position E is now complete and the next relevant record is retrieved for processing.

Further, as custom API 3) has determined that there is a potential new job at position B, pre-programmed API 1) Location API uses reverse geocoding to determine the street address and suburb based on the GPS coordinate from the stored reference record in relation to position B.

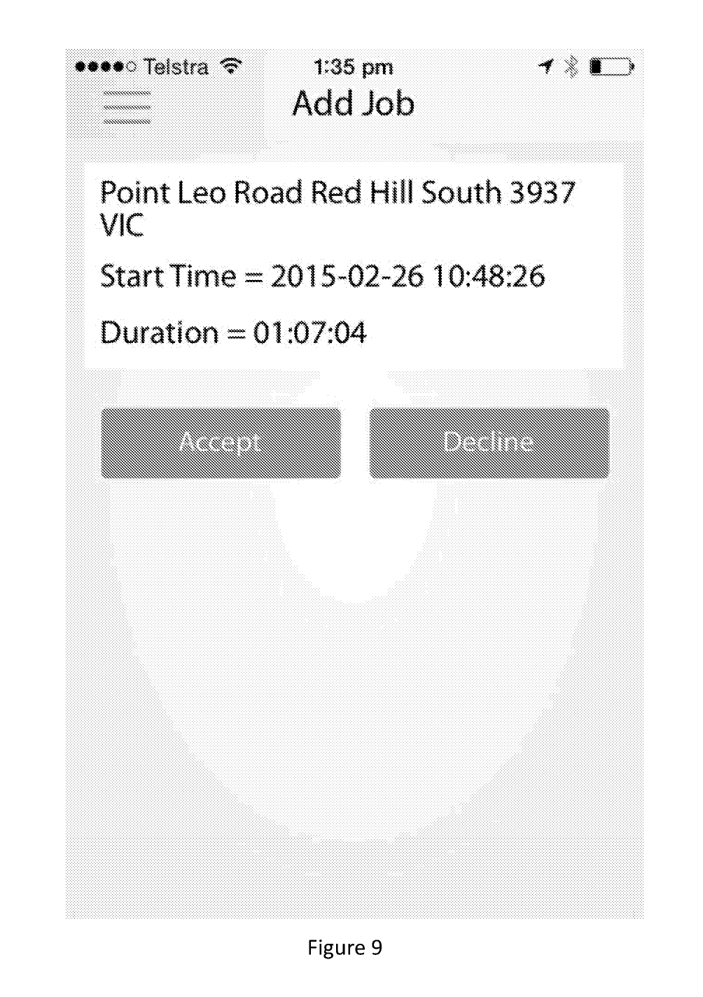

Custom API 3) Create New Job then creates a new job user prompt as to whether position B is a new job site location, on the portable device 13. The user prompt includes presentation of the street address and suburb (as determined by reverse geocoding from GPS coordinate of the stored reference record), and the time elapsed at the potential new job location. The time elapsed, being the calculated time elapsed from the time on the record relating to position E is then compared to the time from the stored reference record in relation to position B. An example of the portable device 13 new job user prompt is included at FIG. 9.

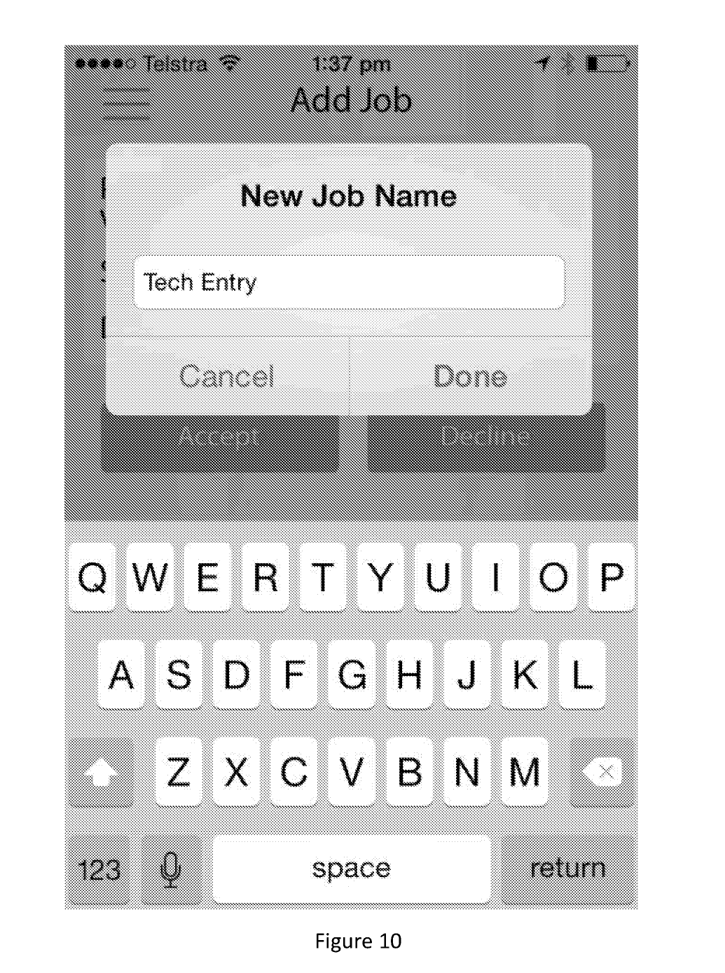

If the technician accepts the new job user prompt (in relation to position B) on the portable device 13, as a new job, the technician receives a further prompt, to capture a job name in relation to the work performed at or around position B. An example of the portable device 13 job name prompt is included at FIG. 10. On entry and confirmation of the job name by the technician, the job name, site address and, suburb (as determined by reverse geocoding) and the GPS coordinate of the stored reference record relating, to position B are added to the stored set of job site locations on the project accounting system 30.

Further, custom API 3) Create New Job takes the technician identifier, date and time as stored on the reference record in relation to position B are logged as the START date and START time for the given technician, on the project accounting system 30. This START entry will be logged against the newly added job on the project accounting system 30.

Similarly, the technician identifier, date and time from the record in relation to Position E are logged as the END date and END time for the given technician on project accounting system 30. This END entry will be logged against the newly added job on project accounting system 30. Also, this particular new job user prompt will be removed from the technician's new job queue on the portable device 13.

Otherwise, if the technician rejects the new job user prompt (in relation to position B) on the portable device 13. The job location and data in relation to Position B will not be added to the stored set of job site locations on the project accounting system 30, and no time or technician readings from the reference record in relation to position B or the record in relation to position E are passed back to the project accounting system 30. This particular new job user prompt will then be removed from the technician's new job queue on the portable device 13.

Further aspects of the method will be apparent from the above description of the system 10. For example, it will be appreciated that the portable device 13 may alternatively comprise a duration data cache provided by a third-party cloud-based database for storing the start time, the end time, or both the start time and the end time. Persons skilled in the art will also appreciate that the method could be embodied in program code. The program code could be supplied in a number of ways, for example on a tangible computer readable medium, such as a disc or a memory (for example, that could replace part of memory) or as a data signal (for example, by transmitting it from a server).

Similarly, it will be appreciated that the data in the location database and the duration database 88 can be supplied on any appropriate tangible data carrier, such as by writing them to a portable device (such as a USB drive), storing them in a memory (including transmitting locations to a device having a memory) etc.

Modifications within the scope of the invention may be readily effected by those skilled in the art. It is to be understood, therefore, that this invention is not limited to the particular embodiments described by way of example hereinabove.

In the claims that, follow and in the preceding description of the invention, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Further, any reference made herein to prior art is not intended to imply that such prior art forms or formed a part of the common general knowledge in Australia or any other country.

1-96. (canceled)

97. A method for automatic time recordal, comprising:
monitoring, by a portable device, a location of the portable device to determine whether or not the location of the portable device matches any one of a set of locations at which a person associated with the portable device is set to perform an activity; and
upon the portable device determining that the location of the portable device matches one of the set of locations, generating duration data for enabling a determination of a duration of time spent by the portable device at the matched location.

98. A method as claimed in claim 97, wherein generating the duration data comprises determining a start time at which the location of the portable device first matches the matched location, and wherein the duration data is indicative of the start time.

99. A method as claimed in claim 97, wherein generating the duration data comprises determining an end time at which the location of the portable device last matches the matched location, and wherein the duration data is indicative of the end time.

100. A method as claimed in claim 97, wherein determining whether or not the location of the portable device matches any one of the set of locations comprises comparing the location of the portable device to each one of the set of locations in order to determine whether or not the location of the location of the portable device is within a predetermined distance of the location.

101. A method as claimed in claim 97, wherein determining that the location of the portable device matches the matched location comprises determining that the location of the portable device is within the predetermined distance of the matched location.

102. A method as claimed in claim 97, wherein the set of locations consists of one location.

103. A method as claimed in claim 97, further comprising determining the set of locations

104. A method as claimed in claim 103, wherein determining the set of locations comprises:
transmitting a location set identifier to a server for the server to locate the set of locations from a plurality of locations stored in a location database based on the location set identifier; and
receiving from the server the set of locations located from the plurality of locations stored in the location database based on the location set identifier.

105. A method as claimed in claim 97, wherein monitoring the portable device comprises monitoring the location of the portable device.

106. A method as claimed in claim 97, wherein monitoring the portable device comprises monitoring a flag that can be set by the portable device.

107. A method as claimed in claim 97, further comprising storing the duration data in a duration database.

108. A method as claimed in claim 97, further comprising transmitting the duration data to a server in communication with a duration database for the server to:
determine the duration of time spent by the portable device at the matched location; and
generate and store in the duration database data indicative of the duration.

109. A method as claimed in claim 97, wherein the location set identifier is an identifier of the person associated with the portable device.

110. A portable device for automatic time recordal, comprising:
a location monitor arranged to monitor a location of the portable device to determine whether or not the location of the portable device matches any one of a set of locations at which a person associated with the portable device is set to perform an activity; and
a duration data generator arranged to, upon the location monitor determining that the location of the portable device matches one of the set of locations, generate duration data for enabling a determination of a duration of time spent by the portable device at the matched location.

111. A device as claimed in claim 110, further comprising memory for storing the duration data.

112. A server for automatic time recordal, the server arranged to:
receive duration data for enabling a determination of a duration of time spent by a portable device at a matched one of a set of locations at which a person associated with the portable device is set to perform an activity;
determine the duration of time spent by the portable device at the matched location based on the duration data,
wherein the duration data is received upon a determination by the portable device that a location of the portable device matches the matched one of the set of locations.

113. A server as claimed in claim 112, further comprising a location set determiner arranged to determine the set of locations,
wherein the location set determiner comprises:
an identifier receiver arranged to receive a location set identifier from the portable device; and
a location set locator arranged to locate the set of locations from a plurality of locations stored in a location database based on the location set identifier.

114. A server as claimed in claim 112, further comprising:
a duration database; and
a duration database modifier arranged to modify the duration database to store the duration data.

115. A method as claimed in claim 97, wherein generating the duration data comprises:
monitoring the portable device to determine whether or not the portable device is at the matched location for a duration of time that exceeds a defined duration of time; and
upon determining that the portable device is at the matched location for a duration of time that exceeds the defined duration of time, generating in memory a location record for (i) enabling a recordal of a duration of time spent by the person at the matched location and (ii) associating the duration of time spent by the person at the matched location with the matched location.
